(19) United States
(12) Patent Application Publication
(10) Pub. No.: US 2025/0111680 A1
(43) Pub. Date: Apr. 3, 2025

(54) ESTIMATION DEVICE AND ESTIMATION METHOD

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Nobuaki MATSUDAIRA, Nisshin-shi (JP); Tomohiro NEZUKA, Nisshin-shi (JP)

(21) Appl. No.: 18/889,907

(22) Filed: Sep. 19, 2024

(30) Foreign Application Priority Data
Sep. 29, 2023 (JP) 2023-168953

(51) Int. Cl. G06V 20/58; G06T 7/50; G06T 7/70; G06V 10/44

(52) U.S. Cl. CPC G06V 20/58; G06T 7/50; G06T 7/70; G06V 10/44; G06T 2207/30252

(57) ABSTRACT

An estimation device includes a coordinate calculation unit, a feature obtaining unit, and a bird's-eye view generation unit. The coordinate calculation unit calculates three-dimensional coordinates of an object present around a vehicle based on two-dimensional images representing outside of a vehicle captured by a plurality of cameras mounted on the vehicle, by using a self-position estimation method including a visual odometry which calculates the three-dimensional coordinates of the object in sequential two-dimensional images captured by a same camera. The feature obtaining unit obtains a bird's-eye view (BEV) feature, which is a feature in a BEV space, based on the three-dimensional coordinates and at least one of the two-dimensional images by using a BEV estimation algorithm. The bird's-eye view generation unit generates a bird's-eye view based on the BEV feature.

### CROSS REFERENCE TO RELATED APPLICATION

The present application claims the benefit of priority from Japanese Patent Application No. 2023-168953 filed on Sep. 29, 2023, the entire disclosures of which are incorporated herein by reference.

### TECHNICAL FIELD

The present disclosure relates to an estimation device and an estimation method.

### BACKGROUND

There is a technology that estimates three-dimensional spatial information based on two-dimensional images acquired by multiple cameras using a machine learning model, and generates a bird's-eye view based on the estimated three-dimensional spatial information.

### SUMMARY

The present disclosure provides an estimation device and an estimation method. According to an aspect of the present disclosure, an estimation device includes: a coordinate calculation unit configured to calculate three-dimensional coordinates of an object present around a vehicle based on sequential two-dimensional images representing outside of a vehicle captured by a same one of a plurality of cameras mounted on the vehicle by using a self-position estimation method including a visual odometry; a feature obtaining unit configured to obtain a bird's-eye view (BEV) feature, which is a feature in a BEV space, based on the three-dimensional coordinates and at least one of the two-dimensional images by using a BEV estimation algorithm; and a bird's-eye view generation unit configured to generate a bird's-eye view, as a top-down perspective image of the vehicle, based on the BEV feature.

### BRIEF DESCRIPTION OF DRAWINGS

Objects, features and advantages of the present disclosure will become more apparent from the following detailed description made with reference to the accompanying drawings, in which:

FIG. 1 is a block diagram illustrating a schematic configuration of a driving assistance system;

FIG. 2 is an explanatory diagram illustrating an example of camera arrangement;

FIG. 3 is an explanatory diagram illustrating coordinate transformation;

FIG. 4 is a flowchart illustrating a method for generating a bird's-eye view according to a first embodiment;

FIG. 5 is a flowchart illustrating a method for generating a bird's-eye view according to a second embodiment; and

FIG. 6 is a flowchart illustrating a method for generating a bird's-eye view according to a third embodiment.

### DETAILED DESCRIPTION

In a technology that uses a machine learning model to estimate three-dimensional spatial information based on two-dimensional images, the accuracy of the estimation result is likely to be affected by training data used in training and a method for training the machine learning model. For example, for an event that has not been trained, the machine learning model may not be able to output correct estimation results. It cannot be said that the estimation results obtained by using the machine learning model be necessarily reliable.

Therefore, there is a demand for a technology that can obtain more reliable estimation results in the estimation of three-dimensional spatial information based on two-dimensional images.

According to an aspect of the present disclosure, an estimation device includes: a coordinate calculation unit, a feature obtaining unit, and a bird's-eye view generation unit. The coordinate calculation unit configured to calculate three-dimensional coordinates of an object present around a vehicle based on two-dimensional images representing outside of the vehicle captured by a plurality of cameras mounted on the vehicle, by using a self-position estimation method including a visual odometry which calculates the three-dimensional coordinates of the object in sequential two-dimensional images captured by a same camera, which is one of the plurality of cameras. The feature obtaining unit is configured to obtain a bird's-eye view (BEV) feature, which is a feature in a BEV space, based on the three-dimensional coordinates and at least one of the two-dimensional images representing outside of the vehicle by using a BEV estimation algorithm. The bird's-eye view generation unit is configured to generate a bird's-eye view, as a top-down perspective image of the vehicle, based on the BEV feature.

According to the estimation device described above, the visual odometry is used and the three-dimensional coordinates of an object around the vehicle are calculated by a geometric method based on two-dimensional images and the intrinsic and extrinsic parameters of the camera. Therefore, it is possible to obtain more reliable estimation results, compared to an estimation configuration in which the three-dimensional coordinates of an object around the vehicle is estimated by using only a machine learning model.

### First Embodiment

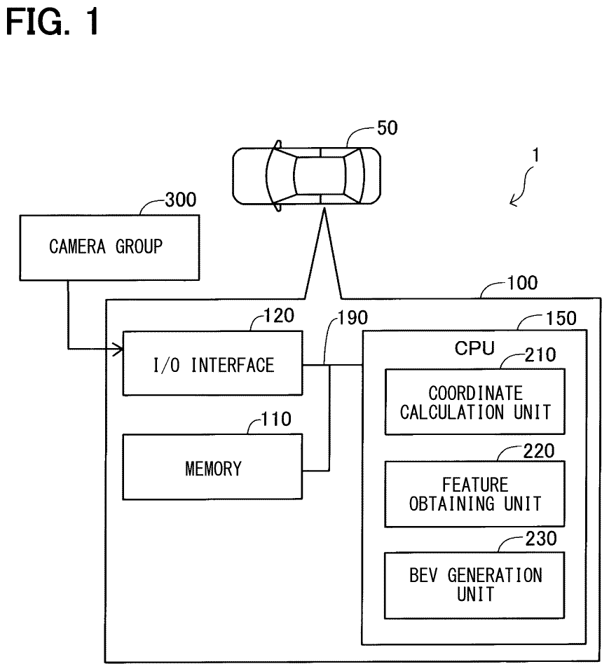

A driving assistance system 1 shown in FIG. 1 estimates the surroundings of a vehicle 50 using multiple two-dimensional images acquired sequentially by an image sensor provided on the vehicle 50 and generates a bird's-eye-view image of the vehicle as viewed from above. The bird's-eye-view image is an image showing an overhead view of the vehicle 50, that is, an image when looking down on the vehicle 50 from above. For example, the driving assistance system 1 uses multiple two-dimensional images acquired sequentially by the image sensor mounted on the vehicle 50 and causes an in-vehicle monitor device mounted on the vehicle 50 to display an image looking down on the vehicle 50 from above. The vehicle 50 is equipped with an advanced driving assistance system (ADAS) and can be driven thereby.

The driving assistance system 1 includes an estimation device 100 and a camera group 300. The estimation device 100 and the camera group 300 are mounted on the vehicle 50.

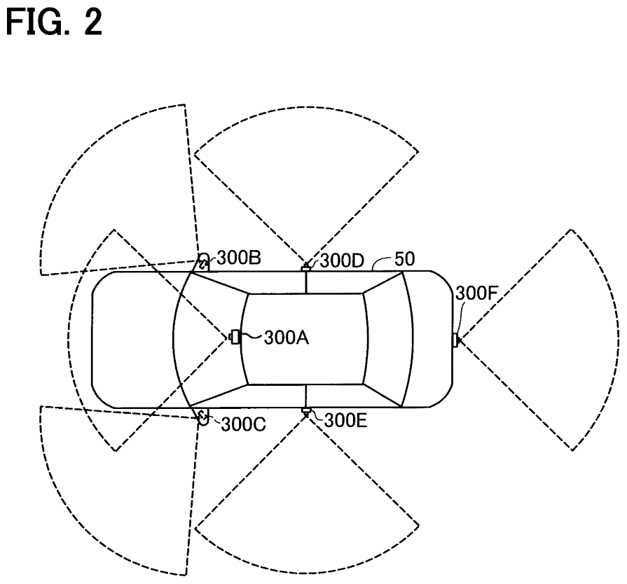

As shown in FIG. 2, the camera group 300 includes six cameras 300A to 300F mounted on the vehicle 50. The cameras 300A to 300F are monocular cameras capable of capturing color images. The camera 300A is disposed at an upper part of a windshield of the vehicle 50. The camera 300A captures an image of a predetermined range in front of the vehicle 50. The camera 300B is disposed at a lower part of a door mirror on a right side of the vehicle 50. Hereinafter, the right side of the vehicle 50 refers to the right side as seen by a person sitting inside the vehicle 50 facing the front of the vehicle 50. The camera 300B captures an image of a predetermined range diagonally forward to the right of the vehicle 50.

The camera 300C is disposed at a lower part a door mirror on a left side of the vehicle 50. The left side of the vehicle 50 refers to the left side as seen by a person sitting inside the vehicle 50 facing the front of the vehicle 50. The camera 300C captures an image of a predetermined range diagonally forward to the left of the vehicle 50. The camera 300D is disposed on a right door pillar of the vehicle 50. The camera 300D captures an image of a predetermined range on the right side of the vehicle 50. The camera 300E is disposed on a left door pillar of the vehicle 50. The camera 300E captures an image of a predetermined range on the left side of the vehicle 50. The camera 300F is disposed at the center of a back door. The camera 300F captures an image of a predetermined range behind the vehicle 50.

The cameras 300A to 300F each capture images of the respective predetermined range outside the vehicle 50 at a predetermined frame rate and output the captured images to the estimation device 100. In the present embodiment, it is assumed that the cameras 300A to 300F capture images at the same timing, for ease of understanding of the technology.

The estimation device 100 is a computer including a memory 110, an input/output interface 120, and a central processing unit (CPU) 150. The memory 110 and the input/output interface 120 are connected to the CPU 150 via a bus 190. For example, functions of the estimation device 100 are realized by a driving-control electronic control unit (ECU) that is responsible for driving control of the vehicle 50.

The memory 110 stores various programs and various data used for various processing executed by the estimation device 100. The memory 110 stores data representing machine learning models used in various processing executed by the estimation device 100.

The cameras 300A to 300F are connected to the input/output interface 120 via Ethernet (registered trademark).

The CPU 150 is a processor that realizes various functions by executing programs stored in the memory 110. For example, the CPU 150 stores in the memory 110 the two-dimensional images received from the cameras 300A to 300F. In an embodiment, the CPU 150 executes the programs stored in the memory 110 to function as a coordinate calculation unit 210, a feature obtaining unit 220, and a bird's-eye view generation unit 230.

The coordinate calculation unit 210 calculates, based on sequential two-dimensional images and using a visual odometry as a self-position estimation method, three-dimensional coordinates of objects in the two-dimensional images. In the present embodiment, the coordinate calculation unit 210 calculates the three-dimensional coordinates of objects present around the vehicle 50 based on the two-dimensional images representing the outside of the vehicle 50 captured by the cameras 300A to 300F and using the visual odometry. The processing executed by the coordinate calculation unit 210 will be described in detail later.

The feature obtaining unit 220 obtains bird eye view (BEV) features, which are features in a BEV space, based on the three-dimensional coordinates of the objects present around the vehicle 50 and the two-dimensional images used to calculate the three-dimensional coordinates. The BEV features include coordinate values of a point cloud in a three-dimensional space and information on the color of the point cloud, similar to point cloud data detected by light detection and ranging (LiDAR). The processing executed by the feature obtaining unit 220 will be described in detail later.

The bird's-eye view generation unit 230 generates a bird's-eye view based on the BEV features. The bird's-eye view is an image showing the surroundings of the vehicle 50 as a top-down perspective as viewed the vehicle 50 from above. An existing technique can be used to generate the bird's-eye view based on the BEV features. The bird's-eye view generation unit 230 can detect objects around the vehicle 50 based on the BEV features and generate the bird's-eye view showing the objects around the vehicle 50. It should be noted that the generated bird's-eye view does not necessarily include all objects around the vehicle 50. For example, the bird's-eye view generation unit 230 may detect lanes around the vehicle 50 based on the BEV features and generate the bird's-eye view including the vehicle 50 and the lanes.

Next, the visual odometry (hereinafter, simply referred to as the VO) will be described. In the VO, feature points are detected in sequential two-dimensional images, which are successive in time series, and three-dimensional coordinates in a world coordinate system of the feature points are estimated using coordinates of the feature points in the two-dimensional images. The feature point is a point that can be reliably detected in the two-dimensional image.

The feature points are detected by using a corner detection technique. For example, the intersection of two edges is detected as a corner. Alternatively, a point at which two distinct edges with different orientations in a local neighborhood is detected as a corner. Examples of the corner detection technique include a Harris corner detection, a scale-invariant feature transform (SHIFT), a speeded up robust features (SURF), and an Oriented FAST and rotated BRIEF (ORB). Further, many of the corner detection techniques can detect not only the corner points but also the feature points. The number of feature points detected from a single two-dimensional image is, for example, 100.

For example, feature points are detected from three sequential two-dimensional images captured by the same camera. The times at which the three sequential two-dimensional images are captured are referred to as t0, t1, and t2. The time to is the earliest time, and the time t2 is the latest time. The feature points are detected in each of the two-dimensional images acquired at the times t0, t1, and t2, and the coordinates and brightness value of each detected feature point are recorded. Examples of the detected feature points include corners of buildings, contours of traffic signs, boundaries of the color of the traffic signs, corners of curbs.

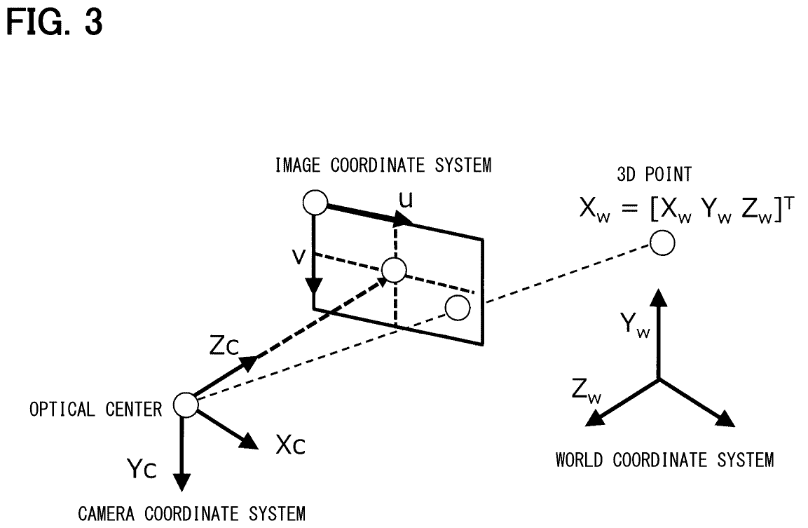

As shown in FIG. 3, the coordinates of the detected feature point are coordinates obtained by projecting a three-dimensional position of an object or the like in a world coordinate system onto an image coordinate system. The relationship between the coordinates in the two-dimensional image of the feature point and the three-dimensional position in the world coordinate system of the feature point can be expressed as the following mathematical formula (1). In the mathematical formula (1), fₓ and f_{y} represent focal lengths, cₓ and c_{y} represent the position of the intersection of an optical axis and a projection plane, r₁₁ to r₃₃ represent rotation matrix, t₁ to t₃ represent translation vectors, and s represents a scale factor. The scale factor s is estimated in advance using measurement results of the position and orientation of the camera by an inertial measurement unit (IMU) or the like.

$$[ Mathematical Formula 1 ]$$

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{3 I} & {r}_{32} & {r}_{33} & {t}_{3}\end{matrix} ] [ \begin{matrix}{X}_{W} \\ {Y}_{W} \\ {Z}_{W} \\ 1\end{matrix} ] \qquad ( 1 )$$

The mathematical formula (1) can be expressed in a form as shown by a mathematical formula (2).

$$[ Mathematical Formula 2 ]$$

$${su}_{I} = K [ \begin{matrix}R & T\end{matrix} ] {X}_{W} \qquad ( 2 )$$

In the mathematical formula (2), the matrix K is called an intrinsic parameter of the camera. The matrix [R T] is called an extrinsic parameter of the camera. The extrinsic parameter of the camera is determined by the position T and orientation R in the camera coordinate system. As shown in the mathematical formula (2), the position u_{I}=[u v 1]^{t} in the two-dimensional image is expressed by a function of the position T and orientation R in the camera coordinate system and the position X_{W}=[X_{W} Y_{W} Z_{W}]^{t} in the world coordinate system.

When the position of the feature point corresponding to the same object or the like detected in multiple sequential two-dimensional images is tracked, the position of the feature point of interest changes with the movement of the vehicle 50, that is, the movement of the camera group 300.

In the VO, the position and orientation of the camera and the three-dimensional coordinates in the world coordinate system of the feature point at the time t1 are estimated based on the position of the feature point detected in each of the two-dimensional images by bundle adjustment. Specifically, the position and orientation of the camera and the three-dimensional coordinates in the world coordinate system of the feature point at the time t1 are calculated using the coordinates of corresponding feature points detected in the multiple two-dimensional images and the assumed position T and orientation R of the camera. The calculated three-dimensional coordinates are then re-projected onto the image coordinate system, and a distance (reprojection error) between the projected point and the feature point detected from the two-dimensional image is estimated.

The position of the feature point in the two-dimensional image can be obtained by a projection function as shown in the following mathematical formula (3). It is assumed that the intrinsic parameter is fixed, and the intrinsic parameter is thus not taken into consideration in the mathematical formula (3). The projection function is a function that maps the coordinate system of the object space (i.e., the world coordinate system) to the coordinate system of the image space (i.e., the image coordinate system).

$$[ Mathematical Formula 3 ]$$

$${u}_{P} = proj ( R , T , {X}_{W} ) \qquad ( 3 )$$

The error between the position u_{I} of the feature point detected from the two-dimensional image and the position uₚ of the feature point obtained from the projection function is defined as in the following mathematical formula (4). In the mathematical formula (4), u_{I} represents a set of coordinates of the feature points detected from the two-dimensional image.

$$[ Mathematical Formula 4 ]$$

$${C}_{cam} = \vert {u}_{I} - proj ( R , T , {X}_{W} ) \vert \qquad ( 4 )$$

By an optimization processing that minimizes the error function C_{cam} expressed by the mathematical formula (4), the three-dimensional coordinates in the world coordinate system of the feature point and the position and orientation of the camera at the time t1 are estimated. The three-dimensional coordinates in the world coordinate system of the estimated feature point are the three-dimensional coordinates in the world coordinate system of the feature point that is in the two-dimensional image acquired at the time t1. The estimated position and orientation of the camera are expressed by a rotation matrix and a translation vector. Minimizing the error expressed by the mathematical formula (4) means minimizing the error between the actual coordinates of the detected feature point in the image and the coordinates of the feature point obtained by the projection function. In this way, in the VO, the three-dimensional coordinates of the object or the like in the world coordinate system are estimated.

Next, a BEV estimation algorithm for estimating the BEV according to the present embodiment will be described. In the present embodiment, a bird's-eye-view image is generated by combining the estimation results of the three-dimensional coordinates of the objects around the vehicle 50 by the VO with a Lift Splat Shoot (LSS) algorithm (Jonah Philion, Sanja Fidler, “Lift, Splat, Shoot: Encoding Images from Arbitrary Camera Rigs by Implicitly Unprojecting to 3D”, in European Conference on Computer Vision. Spinger, 2020, pp. 194-210, or [online], [Retrieved on Feb. 16, 2024], Internet URL: https://arxiv.org/pdf/2008.05711v1.pdf).

In the LSS algorithm, first, two-dimensional images are acquired by the respective cameras 300A to 300F. Feature vectors of multiple two-dimensional images are extracted using a machine learning model such as a convolutional neural network (CNN). The depth of each pixel is estimated based on each two-dimensional image acquired by each camera. Since the estimated depth is ambiguous, a probability distribution of discrete depths is predicted for each pixel, assuming a ray (a ray from the camera to a point in the three-dimensional space) corresponding to that pixel. A cross product of the predicted discrete depth probability distribution and the feature vector is calculated to obtain a series of points as information indicating the depth of the pixel. As a result, a frustum-shaped point cloud is generated for each camera. The BEV feature is generated from the frustum-shaped point cloud using the intrinsic and extrinsic parameters of the camera.

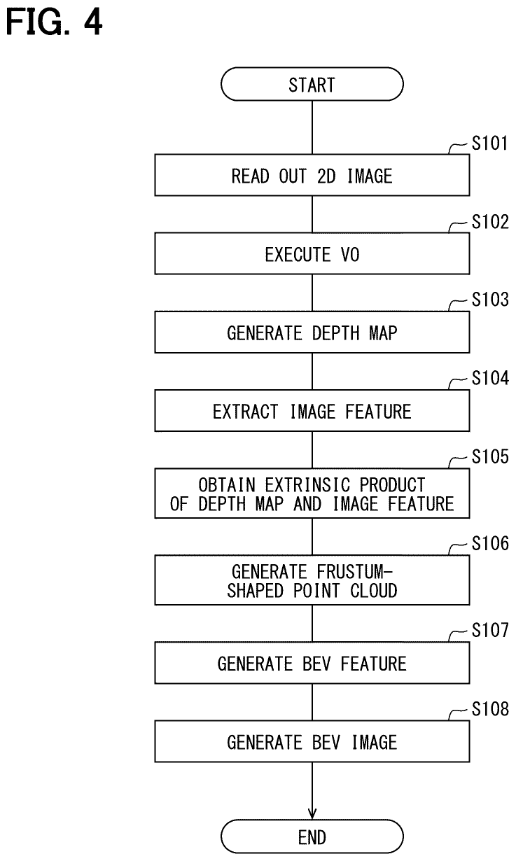

FIG. 4 shows a bird's-eye view estimation method executed by the estimation device 100 according to the present embodiment. For example, the process shown in FIG. 4 begins when the vehicle 50 starts traveling. The cameras 300A to 300F each capture images of the predetermined range outside the vehicle 50 at a predetermined frame rate and output the acquired two-dimensional images to the estimation device 100. The captured two-dimensional images are color images. The two-dimensional images captured by the cameras 300A to 300F are sequentially stored in memory 110.

In S101, the two-dimensional images are read from the memory 110. In S102, the VO is executed. In the present embodiment, the three-dimensional coordinates of an object or the like in the world coordinate system are calculated by the VO based on each of the two-dimensional images captured by the cameras 300A to 300F. The processing of S101 and S102 is executed by the coordinate calculation unit 210.

In S103, a depth map is generated using the three-dimensional coordinates in the world coordinate system calculated in S102 and the two-dimensional image used to calculate the three-dimensional coordinates (i.e., the two-dimensional image acquired at the time t1). The two-dimensional image used to calculate the three-dimensional coordinates (i.e., the two-dimensional image acquired at the time t1) is also referred to as the corresponding image. In the present embodiment, the coordinates are estimated by a feature-based method. For this reason, the coordinates in the world coordinate system are estimated only for the feature point detected from the corresponding image. Therefore, the coordinates in the world coordinate system are not estimated for pixels other than the feature point. As such, the depths of the pixels other than the feature point can be obtained by, for example, linear interpolation using the depths of neighboring pixels. The processing of S103 is executed by the feature obtaining unit 220.

In S104, image features (feature vectors) of the two-dimensional images captured by the camera group 300 are extracted using a machine learning model such as CNN. To extract the image features from the two-dimensional images captured by the camera 300A, a machine learning model that has been trained to take the two-dimensional images captured by the camera 300A as input and to extract image features from the two-dimensional images is used. This machine learning model is generated by machine learning using, as learning data, two-dimensional images captured by a camera attached in a similar position to the camera 300A. In this case, 1×1 convolution is performed to extract the image features. Therefore, the size of the two-dimensional image is not changed. In this case, the corresponding image used to calculate the three-dimensional coordinates (i.e., the two-dimensional image acquired at the time t1) is input. For the cameras 300B to 300F, image features are extracted from the two-dimensional images using the respective machine learning models. The processing of S104 is executed by the feature obtaining unit 220.

In S105, a cross product of the image features extracted in S104 and the depth map generated from the corresponding two-dimensional image is calculated as the cross product feature. The processing of S105 is executed by the feature obtaining unit 220.

In S106, similarly to the LSS algorithm, a frustum-shaped point cloud is generated based on the cross product feature calculated in S105. Specifically, a probability distribution of discrete depths is predicted for each pixel in each two-dimensional image, assuming a ray (a ray from the camera to a point in a three-dimensional space) corresponding to that pixel. The cross product of the predicted discrete depth probability distribution and a vector representing the cross product feature is calculated as the depth. The frustum-shaped point cloud is generated for the two-dimensional image acquired by each camera by using the estimated depth, the coordinates of each pixel of the two-dimensional image, and the intrinsic and extrinsic parameters of the camera. The processing of S106 is executed by the feature obtaining unit 220.

In S107, the BEV features are generated from the frustum-shaped point clouds generated in S106. The processing of S107 is executed by the feature obtaining unit 220. In S108, a bird's-eye-view image is generated from the BEV features. The generated bird's-eye-view image is displayed, for example, on a monitor device provided in the vehicle 50. The processing of S108 is executed by the bird's-eye view generation unit 230. For example, the process shown in FIG. 4 is executed repeatedly at predetermined time intervals while the vehicle 50 is traveling.

In the present embodiment, as described above, the depth map generated based on the three-dimensional coordinate information obtained by the VO is used to generate the bird's-eye view. The three-dimensional coordinates of the object around the vehicle are calculated by a geometric technique based on the two-dimensional images and the intrinsic and extrinsic parameters of the camera by using the VO. Therefore, it is possible to obtain more reliable results in estimating the three-dimensional coordinates of objects around the vehicle. As such, the reliability of the accuracy of the estimated bird's-eye view can be increased, compared to a configuration in which a depth map is generated by three-dimensional coordinate information obtained using a machine learning model and a bird's-eye view is estimated using the generated depth map.

### Second Embodiment

A driving assistance system 1 according to a second embodiment will be described below. The following description will focus on configurations that are different from the first embodiment. Description of the configurations similar to those of the first embodiment will be omitted.

In the present embodiment, a bird's-eye-view image is generated by combining the estimation results of the three-dimensional coordinates of an object around the vehicle 50 obtained by the VO with an algorithm disclosed in US 2023/0053785A1, which is incorporated herein by reference.

In the algorithm disclosed in US2023/0053785A1, first, two-dimensional images are acquired by multiple cameras, respectively. Image features are extracted from the respective two-dimensional images using a backbone network. The backbone network is, for example, the CNN. The image features extracted are input to a transformer engine. The transformer engine is a machine learning model that utilizes an attention mechanism. The transformer engine is a machine learning model that has been trained to take image features extracted from multiple two-dimensional images as input, fuse the image features, and project the fused image features onto the BEV space.

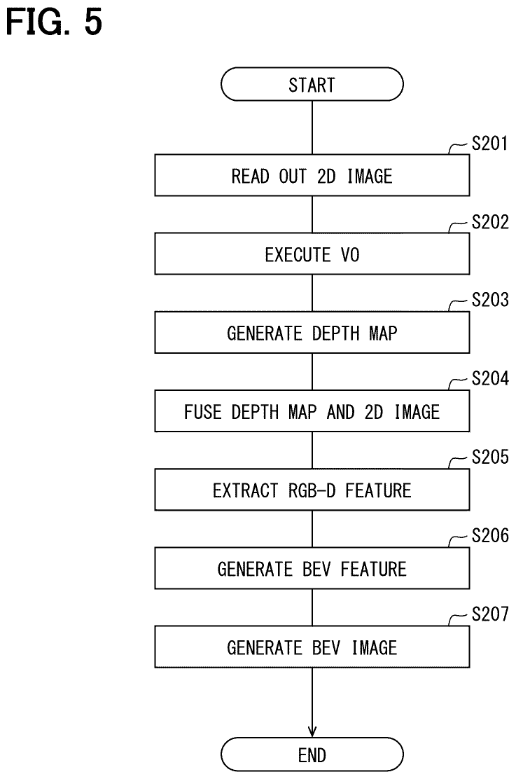

FIG. 5 shows a bird's-eye view estimation method executed by the estimation device 100 according to the present embodiment. For example, the process shown in FIG. 5 begins when the vehicle 50 starts traveling. While the following processing is being executed, the cameras 300A to 300F each capture images of the predetermined range outside the vehicle 50 at a predetermined frame rate and output the captured two-dimensional images to the estimation device 100. The two-dimensional images captured by the cameras 300A to 300F are sequentially stored in the memory 110.

In S201, the two-dimensional images are read from the memory 110. In S202, the VO is executed. In the present embodiment, the three-dimensional coordinates of an object or the like in the world coordinate system are calculated by the VO based on each of the two-dimensional images captured by the cameras 300A to 300F. The processing of S201 and S202 is executed by the coordinate calculation unit 210.

In S203, a depth map is generated using the three-dimensional coordinates in the world coordinate system calculated in S202 and the two-dimensional image used to calculate the three-dimensional coordinates (i.e., the two-dimensional image acquired at the time t1). Similar to the first embodiment, the depths of the pixels other than the feature point are calculated by, for example, linear interpolation using the depths of neighboring pixels. The processing of S203 is executed by the feature obtaining unit 220.

In S204, the depth map obtained in S203 and the corresponding two-dimensional image are fused. The corresponding two-dimensional image is the two-dimensional image that has been used to calculate the three-dimensional coordinates used to generate the depth map. The depth map and the corresponding two-dimensional image are fused, for example, by RGB-D fusion of ASIF-Net algorithm (Chongyi Li and seven others, “ASIF-Net: Attention Steered Interweave Fusion Network for RGB-D Salient Object Detection” in IEEE Transactions on Cybernetics, vol. 51, no. 1, pp. 88-100, January 2021, [online], [Retrieved on Sep. 4, 2023], Internet URL: https://doi.org/10.1109/TCYB.2020.2969255). As a result, RGB-D data is generated. The processing of S204 is executed by the feature obtaining unit 220.

In S205, RGB-D features, which are features in the RGB-D data obtained in S204, are extracted using a backbone network. This backbone network is a trained machine learning model that has been trained to take RGB-D data therein as input and output the RGB-D data features as the features of the RGB-D data. The RGB-D data features also includes features of the depths. The processing of S205 is executed by the feature obtaining unit 220.

In S206, the BEV features in the BEV space are extracted using a transformer engine based on the RGB-D data feature obtained in S205. The processing of S206 is executed by the feature obtaining unit 220.

In S207, a bird's-eye view is generated based on the BEV features obtained in S206. The generated bird's-eye-view image is displayed, for example, on a monitor device provided in the vehicle 50. The processing of S207 is executed by the bird's-eye view generation unit 230. For example, the process shown in FIG. 5 is executed repeatedly at predetermined time intervals while the vehicle 50 is traveling.

In the present embodiment, as described above, the depth map that is generated based on the three-dimensional coordinate information obtained by using the VO is used to generate the bird's-eye view. The three-dimensional coordinates of the object around the vehicle is calculated by the geometric technique based on the two-dimensional images and the intrinsic and extrinsic parameters of the camera by using the VO. Therefore, it is possible to obtain more reliable results in estimating the three-dimensional coordinates of objects around the vehicle. As such, the reliability of the accuracy of the estimated bird's-eye view can be increased, compared to a configuration in which a depth map is generated based on three-dimensional coordinate information obtained using a machine learning model and a bird's-eye view is estimated using the generated depth map.

### Third Embodiment

Hereinafter, a driving assistance system 1 according to a third embodiment will be described. The following description will focus on configurations that are different from the first embodiment. Description of the configurations similar to those of the first embodiment will be omitted.

In the present embodiment, a bird's-eye-view image is generated by combining the estimation results of the three-dimensional coordinates of an object around the vehicle 50 by using the VO with an algorithm of BEVFusion (Zhijian Liu and six others, “BEVFusion: Multi-Task Multi-Sensor Fusion with Unified Bird's-Eye View Representation”, CoRR, 2022, [online], [Retrieved on Feb. 20, 2024], Internet URL: https://arxiv.org/pdf/2205.13542v2.pdf).

In the BEVFusion algorithm, first, two-dimensional images are acquired by multiple cameras, respectively. The image features are extracted in the respective two-dimensional images using a camera encoder model. A bird's-eye view representation for image (image BEV representation) is generated using the image features extracted from multiple two-dimensional images. In addition, LiDAR features are extracted from point clouds detected by LiDAR using a LIDAR encoder model. A bird's-eye view representation for LiDAR (LIDAR BEV representation) is generated using the extracted LiDAR features. The image BEV representation and the LiDAR BEV representation are combined to generate a combined BEV representation. A unified bird's-eye view representation (unified BEV representation) is generated from the combined BEV representation using a BEV encoder. In this case, geometric information and semantic information are both preserved in the unified BEV representation.

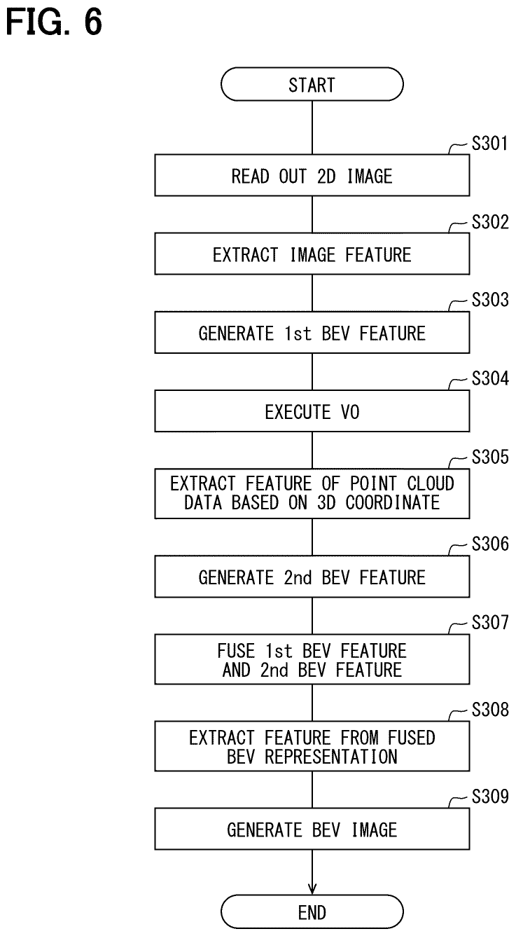

FIG. 6 shows a bird's-eye view estimation method executed by the estimation device 100 according to the present embodiment. For example, the process shown in FIG. 6 begins when the vehicle 50 starts traveling. The cameras 300A to 300F each capture images of the predetermined range outside the vehicle 50 at a predetermined frame rate and output the captured two-dimensional images to the estimation device 100. The two-dimensional images captured by the cameras 300A to 300F are sequentially stored in the memory 110.

In S301, the two-dimensional images are read from the memory 110. In S302, the image features (feature vectors) of the respective two-dimensional images acquired by the cameras 300A to 300F are extracted using a machine learning model such as a camera encoder model. This machine learning model is a trained machine learning model that has been trained to take two-dimensional images therein as input and output the image features, which are the features of the two-dimensional images. The corresponding image (the two-dimensional image acquired at the time t1) used to calculate the three-dimensional coordinates is input to this machine learning model. The processing of S301 and S302 is executed by the feature obtaining unit 220.

In S303, data of a bird's-eye view representation (BEV representation) is generated based on the image features obtained in S302. The generated data of the BEW representation represents a first BEV feature in the BEV space. In this case, similar to the LSS algorithm, a probability distribution of discrete depths is predicted for each pixel in each two-dimensional image, assuming a ray (a ray from the camera to a point in a three-dimensional space) corresponding to that pixel. A cross product of the probability distribution of the predicted discrete depth and the feature vector is calculated as the depth. A frustum-shaped point cloud is generated for the two-dimensional images acquired by each camera, by using the estimated depth, the coordinates of each pixel of the two-dimensional image, and the intrinsic and extrinsic parameters of the camera. The first BEV feature is generated from the frustum-shaped point cloud. The processing of S303 is executed by the feature obtaining unit 220.

In S304, the VO is executed. In the present embodiment, the three-dimensional coordinates of an object or the like in the world coordinate system are calculated based on each of the two-dimensional images acquired by the cameras 300A to 300F by using the VO. The data of the point cloud is generated by using the estimated three-dimensional coordinates. The processing of S304 is executed by the coordinate calculation unit 210.

In S305, three-dimensional features, which are features of the point cloud data generated based on the three-dimensional coordinates obtained in S304, are extracted using a machine learning model such as a LIDAR encoder model. This machine learning model is a trained machine learning model that has been trained to take point cloud data therein as input and output three-dimensional features. This machine learning model is also referred to as a second machine learning model. The processing of S305 is executed by the feature obtaining unit 220.

In S306, data of bird's-eye view representation (BEV representation) is generated based on the three-dimensional features obtained in S305 using the machine learning model. The BEV representation data generated here represents a second BEV feature as a feature in the BEV space. This machine learning model is a trained machine learning model that has been trained to take three-dimensional features therein as input and output the second BEV feature. The processing of S306 is executed by the feature obtaining unit 220.

In S307, the first BEV feature obtained in S303 and the second BEV feature obtained in S306 are fused to generate a fused feature. The processing of S307 is executed by the feature obtaining unit 220.

In S308, features in the unified BEV representation are extracted based on the fused feature using a machine learning model such as a BEV encoder. The processing of S308 is executed by the feature obtaining unit 220. In S309, a bird's-eye-view image is generated from the fused feature. The generated bird's-eye-view image is displayed, for example, on a monitor device provided in the vehicle 50. The processing of S309 is executed by the bird's-eye view generation unit 230. For example, the process shown in FIG. 6 is executed repeatedly at predetermined time intervals while the vehicle 50 is traveling.

As described above, in the present embodiment, the second BEV feature used to estimate the bird's-eye view is generated based on three-dimensional coordinate information obtained by using the VO. The three-dimensional coordinates of the object around the vehicle are calculated by the geometric technique based on the two-dimensional images and the intrinsic and extrinsic parameters of the camera by using the VO. Therefore, it is possible to obtain more reliable results in estimating the three-dimensional coordinates of objects around the vehicle. As such, the reliability of the accuracy of the estimated bird's-eye view can be increased, compared to a configuration in which the second BEV feature is generated based on three-dimensional coordinates obtained by using a machine learning model and the bird's-eye view is estimated by using the generated second BEV feature.

In addition, in the present embodiment, the feature points in the world coordinate system estimated by the VO are used in place of the point cloud detected by the LiDAR. Therefore, there is no need to use the LiDAR which is expensive.

### Other Embodiments

While the exemplary embodiments and examples have been chosen to illustrate the present disclosure, it will be apparent to those skilled in the art from this disclosure that various changes and modifications can be made therein without departing from the scope of the disclosure as defined in the appended claims. For example, the embodiments described above may be modified as follows.

Modified Embodiment 1: In the first embodiment, an example in which the VO is used as the self-position estimation method has been described. However, as the self-position estimation method, a visual inertial odometry (hereinafter, VIO) may be used. In the VIO, a camera and an inertial sensor are used. Also in the configurations according to the second and third embodiments, the VIO can be used as the self-position estimation method. In such a configuration, measurement values by an inertial measurement unit are used, in addition to two-dimensional images, to estimate the three-dimensional coordinates of objects around the vehicle. Therefore, it is possible to obtain more reliable results in estimating the bird's-eye view.

Modified Embodiment 2: In any of the first to third embodiments, the VIO can be used as the self-position estimation method, as well as detection values from a wheel speed sensor can be used. For example, an inertial measurement unit (IMU) having a correction function by using wheel speed can be used. That is, the measurement values by the inertial measurement unit and the detection values by the wheel speed sensor are used. In this case, the vehicle 50 is assumed to be equipped with the wheel speed sensor. The measurement values by the inertial measurement unit and the detection values from the wheel speed sensor are used, in addition to two-dimensional images, to estimate the three-dimensional coordinates of objects around the vehicle. Therefore, it is possible to obtain more reliable results in estimating the bird's-eye view.

Modified Embodiment 3: In the first embodiment, an example in which the coordinates of objects around the vehicle 500 are estimated using the feature-based method has been described. Alternatively, the coordinates of objects around the vehicle 500 may be estimated by a direct method. The depth can be restored for all pixels in the image, for example, by DTAM (Richard A. Newcombe, and two others, “DTAM: Dense Tracking and Mapping in Real-Time”, [online], [Retrieved on Sep. 4, 2023], Internet URL: https://doi.org/10.1109/iccv.2011.6126513).

Modified Embodiment 4: In the first embodiment, an example in which the coordinates of objects around the vehicle 50 are estimated by the feature-based method, and the depth of pixels other than the feature points is interpolated by the linear interpolation has been described. Alternatively, the depth can be interpolated using a depth interpolation method using a machine learning model (Alex Wong, et al., “Unsupervised Depth Completion from Visual Inertial Odometry”, IEEE Robotics and Automation Letters, 5 (2), 1899-1906. [online], [Retrieved on Sep. 4, 2023], Internet URL: https://doi.org/10.1109/Ira.2020.2969938).

Modified Embodiment 5: In the first embodiment, an example in which the processing is executed sequentially as shown in FIG. 4 has been described. Alternatively, the processing of S102 and S103 and the processing of S104 in FIG. 4 may be executed in parallel.

Modified Embodiment 6: In the third embodiment, an example in which the processing is executed sequentially as shown in FIG. 6 has been described. Alternatively, the processing of S302 and S303 and the processing of S304 to S306 in FIG. 6 may be executed in parallel.

The estimation device and the methods therefor according to the present disclosure may be implemented by one or more special-purposed computers. Such a special-purposed computer may be provided (i) by configuring (a) a processor and a memory programmed to execute one or more functions embodied by a computer program. Alternatively, the estimation device and method therefor described in the present disclosure may be implemented in a special purpose computer provided by configuring a processor with one or more special purpose hardware logic circuits. Alternatively, the estimation device and the method therefor described in the present disclosure may be achieved using one or more dedicated computers constituted by a combination of a processor and a memory programmed to execute one or more functions and a processor formed of one or more hardware logic circuits. The computer program may be stored, as instructions to be executed by a computer, in a tangible non-transitory computer-readable storage medium.

The present disclosure should not be limited to the embodiments described above, and various other embodiments may be implemented without departing from the scope of the present disclosure. For example, the technical features in the embodiments can be replaced or combined as appropriate in order to solve a part or all of the issues described above or in order to obtain a part or all of the effects described above. Also, if the technical features are not described as essential in the present specification, they can be deleted as appropriate.

What is claimed is:

1. An estimation device comprising:
a coordinate calculation unit configured to calculate three-dimensional coordinates of an object present around a vehicle based on two-dimensional images representing outside of the vehicle captured by a plurality of cameras mounted on the vehicle, by using a self-position estimation method including a visual odometry which calculates the three-dimensional coordinates of the object in sequential two-dimensional images captured by a same camera, which is one of the plurality of cameras;
a feature obtaining unit configured to obtain a bird's-eye view (BEV) feature, which is a feature in a BEV space, based on the three-dimensional coordinates and at least one of the two-dimensional images representing outside of the vehicle by using a BEV estimation algorithm; and
a bird's-eye view generation unit configured to generate a bird's-eye view, as a top-down perspective image of the vehicle, based on the BEV feature.

2. The estimation device according to claim 1, wherein
the feature obtaining unit is configured to:
generate, using the three-dimensional coordinates, a depth map of each of the two-dimensional images used to calculate the three-dimensional coordinates;
obtain image features, which are features in the two-dimensional images, by inputting the two-dimensional images captured by each of the plurality of cameras into a corresponding one of a plurality of machine learning models, each of the plurality of machine learning models having been trained to take therein the two-dimensional images captured by a corresponding one of the plurality of cameras as input and to output the image features;
generate a frustum-shaped point cloud of the two-dimensional images captured by each of the plurality of cameras by using the image features of the two-dimensional images captured by the corresponding one of the plurality of cameras and the depth maps of the corresponding two-dimensional images; and
generate the BEV feature based on the frustum-shaped point cloud.

3. The estimation device according to claim 2, wherein
the self-position estimation method includes a visual inertial odometry.

4. The estimation device according to claim 3, wherein
the self-position estimation method further includes estimation using a detection value of a wheel speed sensor.

5. The estimation device according to claim 1, wherein
the feature obtaining unit is configured to:
generate, using the three-dimensional coordinates, a depth map of each of the two-dimensional images used to calculate the three-dimensional coordinates;
generate RGB-D data by fusing the two-dimensional image and the depth map corresponding to the two-dimensional image;
obtain an RGB-D data feature, which is a feature of the RGB-D data, by inputting the RGB-D data generated based on the two-dimensional image captured by each of the plurality of cameras into a corresponding one of a plurality of machine learning models, each of the plurality of machine learning models having been trained to take therein the RGB-D data generated based on the two-dimensional image captured by a corresponding one of the plurality of cameras as input and output the RGB-D data feature; and
generate the BEV feature based on the RGB-D data feature.

6. The estimation device according to claim 5, wherein
the self-position estimation method includes a visual inertial odometry.

7. The estimation device according to claim 6, wherein
the self-position estimation method further includes estimation using a detection value of a wheel speed sensor.

8. The estimation device according to claim 1, wherein
the feature obtaining unit is configured to:
obtain image features, which are features in the two-dimensional images, by inputting the two-dimensional images captured by each of the plurality of cameras into a corresponding one of a plurality of first machine learning models each trained to take therein the two-dimensional images captured by a corresponding one of the plurality of cameras as input and output the image features;
generate a first BEV feature, which is a feature in the BEV space, based on the image features;
obtain a three-dimensional feature, which is a feature of the three-dimensional coordinates, by inputting the three-dimensional coordinates into a second machine learning model having been trained to take therein the three-dimensional coordinates as input and output the three-dimensional feature; and
generate a second BEV feature, which is a feature in the BEV space, based on the three-dimensional feature, and
the bird's-eye view generation unit is configured to generate the bird's-eye view based on a fused feature obtained by fusing the first BEV feature and the second BEV feature.

9. The estimation device according to claim 8, wherein
the self-position estimation method includes a visual inertial odometry.

10. The estimation device according to claim 9, wherein
the self-position estimation method further includes estimation using a detection value of a wheel speed sensor.

11. An estimation method comprising:
calculating three-dimensional coordinates of an object present around a vehicle based on two-dimensional images representing outside of the vehicle captured by a plurality of cameras mounted on the vehicle, by using a self-position estimation method including a visual odometry which calculates the three-dimensional coordinates of the object in sequential two-dimensional images captured by a same camera, which is one of the plurality of cameras;
obtaining a bird's eye view (BEV) feature, which is a feature in a BEV space, based on the three-dimensional coordinates and at least one of the two-dimensional images representing outside of the vehicle by a BEV estimation algorithm; and
generating a bird's-eye view, as a top-down perspective image of the vehicle, based on the BEV feature.

12. An estimation device comprising a processor and a memory that stores instructions configured to, when executed by the processor, cause the processor to perform operations including:
calculating three-dimensional coordinates of an object present around a vehicle based on two-dimensional images representing outside of the vehicle capture by a plurality of cameras mounted on the vehicle, by a self-position estimation method including a visual odometry which calculates the three-dimensional coordinates of the object based on the sequential two-dimensional images captured by a same camera, which is one of the plurality of cameras;
obtaining a bird's eye view (BEV) feature, which is a feature in a BEV space, based on the three-dimensional coordinates and at least one of the two-dimensional images representing outside of the vehicle by a BEV estimation algorithm; and
generating a bird's-eye view, as a top-down perspective image of the vehicle, based on the BEV feature.
